(19) United States
(12) Patent Application Publication
(10) Pub. No.: US 2016/0224005 A1
(43) Pub. Date: Aug. 4, 2016

(54) TOOL PATH GENERATION APPARATUS, TOOL PATH GENERATION METHOD, PROGRAM FOR PROVIDING FUNCTION AS TOOL PATH GENERATION APPARATUS, AND STORAGE MEDIUM HAVING THE PROGRAM STORED THEREIN

(71) Applicant: SIGMA INC., Hyogo (JP)

(72) Inventors: Kazuo Morichi, Hyogo (JP); Takashi Ohira, Hyogo (JP)

(73) Assignee: SIGMA INC., Hyogo (JP)

(21) Appl. No.: 15/021,643

(22) PCT Filed: Aug. 26, 2014
(86) PCT No.: PCT/JP2014/072253

§ 371 Date: Mar. 11, 2016

(30) Foreign Application Priority Data
Sep. 13, 2013 (JP) 2013-190839

(51) Int. Cl. G05B 19/19

(52) U.S. Cl. CPC G05B 19/19; G05B 2219/39573; G05B 2219/40512

(57) ABSTRACT

A tool path generation apparatus, a tool path generation method, and a program for generating, in a simple manner, a path with which a tool load is prevented from being excessive, regardless of a shape, and machining efficiency is high, are provided. Until it becomes impossible to generate a machining path (60) within an interior of a tool movement limit line (30), a tool movement region formed by a tool T moving according to the machining path (60) is removed from an unmachined portion (40) in a machining range (20) to update the unmachined portion (40), a contour line (45) of a portion of the updated unmachined portion (40) which portion is to be cut by the tool (T) is newly set, the contour line (45) is offset by a difference between a radius (r1) of the tool (T) and a pitch (p) and a portion (47) located at an offset contour line (46) and within the interior of the tool movement limit line (30) is extracted to generate a cutting path (61), and return paths (62) having a circular arc shape are imparted to both ends of the cutting path (61), to generate a next machining path (60).

### TECHNICAL FIELD

The present invention relates to a tool path generation apparatus, a tool path generation method, a program for providing function as the tool path generation apparatus, and a storage medium having the program stored therein, and more specifically relates to a tool path generation apparatus and a tool path generation method for generating a tool path, for a tool, for moving the rotating tool on a plane orthogonal to a rotation axis of the rotating tool to continuously cut a cut part of a work piece at a predetermined pitch along the plane, a program for providing function as the tool path generation apparatus, and a storage medium having the program stored therein.

### BACKGROUND ART

Conventionally, in, for example, machining (pocket machining) of cutting out a region of a work piece, a path P that extends around so as to be offset from an outer contour B of the region as shown in FIG. 11 is known as a path applicable to high-speed machining. However, many bends occur in the path P, so that a load on a tool does not become uniform. In particular, a load on the tool is great at a portion where the path P shifts from a circuit to another circuit.

Thus, in order to stabilize the tool load, a path generation method as disclosed in, for example, Patent Document 1 is known. In this method, a path on which an angle of contact between a machining part and a cutting tool is equal to or less than a predetermined angle is calculated. However, a calculation to obtain a path, on which the angle of contact is equal to or less than the predetermined angle, in accordance with a shape as appropriate is complicated, and the generated path may not be a path providing good machining efficiency since the angle of contact is prioritized.

Also, as shown in FIG. 12, a method is known in which line segments that are cut within the interior of an outer contour B of a machining range and along parallel lines L extending along a machining direction and arranged at regular intervals are generated as a path P at a portion where a shape is actually cut. However, when the path P is branched in an island shape as show in FIG. 12(a), merging after the path P is divided has to be considered, and machining is performed on the same location two or more times if path generation is performed for both branches. With a shape as shown in FIG. 12(b), paths P that are line segments obtained by cutting parallel lines with an outer contour B are separated as a plurality of paths, but there is no branch, and thus an advance from one side and a return are needed. As described above, depending on the shape of the machining range, it may be difficult to generate a path providing good machining efficiency.

Moreover, it is possible to generate a spiral path by extending a spiral from a machining start point to an outer contour of a machining range. However, if the outer contour is not a circle, it is difficult to generate a spiral that fills the entire machining range. In particular, when the machining start point is located at one side in the machining range, there is impossibility with a spiral having a uniform pitch, and there is no choice but to change the pitch or to newly perform machining by another method after machining with the uniform pitch, which is inefficient.

### CITATION LIST

### [Patent Documents]

[PATENT DOCUMENT 1] US Patent Application Publication No. 2011/0178629

### SUMMARY OF THE INVENTION

### Problems to be Solved by the Invention

An object of the present invention, in view of such conventional circumstances, is to provide a tool path generation apparatus and a tool path generation method for generating, in a simple manner, a path with which a tool load is prevented from being excessive, regardless of a shape, and machining efficiency is high, a program for providing function as the tool path generation apparatus, and a storage medium having the program stored therein.

### Solution to the Problems

In order to achieve the above object, a tool path generation apparatus according to the present invention is characterized by being configured to generate a tool path, for a tool, for moving the rotating tool on a plane orthogonal to a rotation axis of the rotating tool to continuously cut a cut part of a work piece at a predetermined pitch along the plane, the tool path generation apparatus including: a tool movement limit line setting section configured to inwardly offset a machining range based on shape data of the cut part by at least a radius of the tool to set a tool movement limit line; a contour line setting section configured to set a contour line of a portion that is to be cut by the tool; a machining path generation section configured to offset the contour line by a difference between the radius of the tool and the pitch and extract a portion located at an offset contour line and within an interior of the tool movement limit line to generate a cutting path, and impart return paths having a circular arc shape to both ends of the cutting path, to generate a machining path; an unmachined portion update section configured to remove a tool movement region formed by the tool moving according to the machining path, from an unmachined portion in the machining range to update the unmachined portion; and a connection path generation section configured to generate a connection path that connects the machining path to an immediately previously generated machining path, wherein, until it becomes impossible to generate the machining path within the interior of the tool movement limit line, the unmachined portion update section updates the unmachined portion on the basis of the machining path, the contour line setting section newly sets the contour line in the updated unmachined portion, the machining path generation section generates a next machining path on the basis of the newly set contour line, and the connection path generation section generates a connection path that connects the generated next machining path and the machining path.

According to the above configuration, the machining path generation section offsets the contour line of the portion that is to be cut by the tool, by the difference between the radius of the tool and the pitch, and extracts the portion located at the offset contour line and within the interior of the tool movement limit line to generate the cutting path. The portion that is to be cut by the tool is an unmachined portion that has not been cut yet in the machining range, and the contour line thereof indicates a portion that should be cut next. Thus, the cutting path is generated always on the basis of the unmachined portion. In addition, since the portion located at the offset contour line and within the interior of the tool movement limit line is extracted and set as the cutting path, the tool moving on the cutting path does not interfere with the work piece. Also, since the machining path generation section imparts the return paths having a circular arc shape to both ends of the cutting path to generate the machining path, the path can be smooth without a sudden path change, and a tool load does not excessively (suddenly) increase and is stabilized. Furthermore, since the unmachined portion update section removes the tool movement region formed by the tool moving according to the generated machining path, from the unmachined portion in the machining range to update the unmachined portion, the contour line is always based on the unmachined portion. Therefore, it is made possible to generate a tool path that fills a major part of the machining range and provides good machining efficiency, by updating the unmachined portion on the basis of the machining path, newly setting the contour line in the updated unmachined portion, generating the next machining path on the basis of the newly set contour line, and generating the connection path that connects the generated next machining path and the machining path, until it becomes impossible to generate the machining path within the interior of the tool movement limit line.

When a plurality of the offset contour lines are separately generated by the tool movement limit line, the machining path generation section may select any of the plurality of the generated offset contour lines and may generate the next machining path. Accordingly, for example, even with a shape in which a branch occurs in the unmachined portion, generation of the tool path can be continued, and a tool path providing higher machining efficiency can be generated.

The connection path generation section may generate, as the connection path, a line segment that connects the return path of the machining path and a return path of the next machining path such that directions in which the tool advances on the cutting path of the machining path and a cutting path of the next machining path are a certain direction. Accordingly, the path can be smooth without a sudden path change, and a tool load can be stabilized. In this case, the line segment is desirably a tangential line that is in contact with the return path of the machining path and the return path of the next machining path. Accordingly, the machining paths can be connected in a shortest distance, and the machining efficiency improves.

When an extension portion that extends through an outside of the tool movement limit line occurs in the connection path, the connection path generation section may correct the extension portion of the connection path such that the extension portion extends along the tool movement limit line. In addition, when an interference portion that interferes with the unmachined portion occurs in the connection path, the connection path generation section may correct the interference portion of the connection path such that the interference portion extends along a bypass line that is offset from the unmachined portion by the radius of the tool. By these corrections, the tool moving on the connection path is prevented from interfering with the work piece.

When the return path cannot be imparted to the next machining path within the interior of the tool movement limit line, the machining path generation section may reduce a radius of the return path such that the return path falls within the interior of the tool movement limit line. Accordingly, a remaining portion to be cut can be reduced, and the machining efficiency further improves.

The tool path generation apparatus may further include: an initial unmachined portion setting section configured to set the machining range as an initial unmachined portion; and a machining start path generation section configured to generate a machining start path from which cutting the initial unmachined portion is started, and when the cut part has a shape having an opening at at least a part of an outer periphery on the plane, the machining start path generation section may offset a contour line of the initial unmachined portion corresponding to the opening by the difference between the radius of the tool and the pitch, and may extract a portion located at an offset contour line and within the interior of the tool movement limit line, to generate the machining start path, and the unmachined portion update section may remove the tool movement region from the initial unmachined portion according to the machining start path to update the unmachined portion. Accordingly, with a shape (an open pocket) having an opening at at least a part of an outer periphery, cutting with a predetermined pitch (an amount of cutting-in) can be started from the opening, and a smooth tool path can be generated.

In addition, the tool path generation apparatus may further include: an initial unmachined portion setting section configured to set the machining range as an initial unmachined portion; and a machining start path generation section configured to generate a machining start path from which cutting the initial unmachined portion is started, and when the cut part includes an introduction portion through which the tool is introduced, and has a shape having a closed outer periphery on the plane, the machining start path generation section may set, as the machining start path, a spiral having the pitch and extending from a portion corresponding to the introduction portion until coming into contact with the tool movement limit line, and the unmachined portion update section may remove the tool movement region from the initial unmachined portion according to the machining start path to update the unmachined portion. Accordingly, with a shape (a closed pocket) having a closed outer periphery, cutting with a predetermined pitch can be started from a machining start position, and a next machining path can be generated successively after the tool comes into contact with the machining range, which is efficient.

Moreover, in order to achieve the above-described object, a tool path generation method according to the present invention is characterized by a method for generating a tool path, for a tool, for moving the rotating tool on a plane orthogonal to a rotation axis of the rotating tool to continuously cut a cut part of a work piece at a predetermined pitch along the plane, the tool path generation method including: a tool movement limit line setting step of inwardly offsetting a machining range based on shape data of the cut part by at least a radius of the tool to set a tool movement limit line; a contour line setting step of setting a contour line of a portion that is to be cut by the tool; a machining path generation step of offsetting the contour line by a difference between the radius of the tool and the pitch and extracting a portion located at an offset contour line and within an interior of the tool movement limit line to generate a cutting path, and imparting return paths having a circular arc shape to both ends of the cutting path, to generate a machining path; an unmachined portion update step of removing a tool movement region formed by the tool moving according to the machining path, from an unmachined portion in the machining range to update the unmachined portion; and a connection path generation step of generating a connection path that connects the machining path to an immediately previously generated machining path, wherein, until it becomes impossible to generate the machining path within the interior of the tool movement limit line, repeatedly, the unmachined portion is updated by the unmachined portion update step on the basis of the machining path, the contour line in the updated unmachined portion is newly set by the contour line setting step, a next machining path is generated by the machining path generation step on the basis of the newly set contour line, and a connection path that connects the generated next machining path and the machining path is generated by the connection path generation step.

In addition, any tool path generation apparatus described above is realized by a computer program for causing a computer to function as any tool path generation apparatus described above, and the computer program is stored in a storage medium.

In order to achieve the above-described object, a program for providing function as a tool path generation apparatus according to the present invention is characterized by a program for causing a computer to function as a tool path generation apparatus for generating a tool path, for a tool, for moving the rotating tool on a plane orthogonal to a rotation axis of the rotating tool to continuously cut a cut part of a work piece at a predetermined pitch along the plane, the program causing the computer to function as: tool movement limit line setting means for inwardly offsetting a machining range based on shape data of the cut part by at least a radius of the tool to set a tool movement limit line; contour line setting means for setting a contour line of a portion that is to be cut by the tool; machining path generation means for offsetting the contour line by a difference between the radius of the tool and the pitch and extracting a portion located at an offset contour line and within an interior of the tool movement limit line to generate a cutting path, and imparting return paths having a circular arc shape to both ends of the cutting path, to generate a machining path; unmachined portion update means for removing a tool movement region formed by the tool moving according to the machining path, from an unmachined portion in the machining range to update the unmachined portion; and connection path generation means for generating a connection path that connects the machining path to an immediately previously generated machining path, wherein, until it becomes impossible to generate the machining path within the interior of the tool movement limit line, the unmachined portion update means updates the unmachined portion on the basis of the machining path, the contour line setting means newly sets the contour line in the updated unmachined portion, the machining path generation means generates a next machining path on the basis of the newly set contour line, and the connection path generation means generates a connection path that connects the generated next machining path and the machining path.

In order to achieve the above-described object, a computer-readable storage medium having stored therein a program for providing function as a tool path generation apparatus according to the present invention is characterized by a computer-readable storage medium having stored therein a computer program for causing a computer to function as a tool path generation apparatus for generating a tool path, for a tool, for moving the rotating tool on a plane orthogonal to a rotation axis of the rotating tool to continuously cut a cut part of a work piece at a predetermined pitch along the plane, the computer program causing the computer to function as: tool movement limit line setting means for inwardly offsetting a machining range based on shape data of the cut part by at least a radius of the tool to set a tool movement limit line; contour line setting means for setting a contour line of a portion that is to be cut by the tool; machining path generation means for offsetting the contour line by a difference between the radius of the tool and the pitch and extracting a portion located at an offset contour line and within an interior of the tool movement limit line to generate a cutting path, and imparting return paths having a circular arc shape to both ends of the cutting path, to generate a machining path; unmachined portion update means for removing a tool movement region formed by the tool moving according to the machining path, from an unmachined portion in the machining range to update the unmachined portion; and connection path generation means for generating a connection path that connects the machining path to an immediately previously generated machining path, wherein, until it becomes impossible to generate the machining path within the interior of the tool movement limit line, the unmachined portion update means updates the unmachined portion on the basis of the machining path, the contour line setting means newly sets the contour line in the updated unmachined portion, the machining path generation means generates a next machining path on the basis of the newly set contour line, and the connection path generation means generates a connection path that connects the generated next machining path and the machining path.

### Advantageous Effects of the Invention

According to the features of the above-described tool path generation apparatus, the above-described tool path generation method, the above-described program for providing function as the tool path generation apparatus, and the above-described storage medium having the program stored therein according to the present invention, it is made possible to generate, in a simple manner, a path with which a tool load is prevented from being excessive, regardless of a shape, and machining efficiency is high.

Other objects, configurations, and effects of the present invention will become apparent from the following description of embodiments of the invention.

### BRIEF DESCRIPTION OF THE DRAWINGS

FIG. 1 is a hardware configuration diagram of a tool path generation apparatus according to the present invention.

FIG. 2 is a software configuration diagram of the tool path generation apparatus according to the present invention.

FIG. 3 A diagram FIG. 3(a) shows an example of a work piece, a diagram FIG. 3(b) shows a relationship between a machining range corresponding to a cut part in the diagram FIG. 3(a), a tool movement limit line, and an unmachined portion, and a diagram FIG. 3(c) shows a relationship between an unmachined portion contour line and a machining path.

FIG. 4 A diagram FIG. 4(a) shows a relationship between the machining range corresponding to the cut part in FIG. 3(a) and an initial unmachined portion, and a diagram FIG. 4(b) illustrates generation of a machining start path.

FIG. 5(a), FIGS. 5(b), and 5(c) illustrate adjustment of the radius of a return path, a diagram FIG. 5(a) shows a state before the adjustment, a diagram FIG. 5(b) shows a state after the adjustment, and a diagram FIG. 5(c) shows a state where the unmachined portion has been updated on the basis of the machining path after the adjustment.

FIG. 6 is a diagram illustrating correction of a connection path.

FIG. 7 is a flowchart showing a process of tool path generation.

FIG. 8a(a)-8a(f) are diagrams showing a tool path generation procedure.

FIG. 8b(g)-8b(k) are diagrams showing the tool path generation procedure.

FIG. 9a(a)-9a(c) are diagrams illustrating generation of a machining path in the case where a plurality of contour lines occur.

FIG. 9b(d)-9b(g) are diagrams illustrating the generation of the machining path in the case where a plurality of contour lines occur.

FIG. 10a(a)-10a(f) are diagrams illustrating generation of a machining start path in another embodiment of the present invention.

FIG. 10b(g)-10b(j) are diagrams illustrating the generation of the machining start path in the other embodiment of the present invention.

FIG. 11 is a diagram showing an example of generation of a conventional tool path.

FIGS. 12(a) and 12(b) are diagrams showing an example of generation of other conventional tool paths.

### DESCRIPTION OF EMBODIMENTS

Next, the present invention will be described in further detail with appropriate reference to the accompanying drawings.

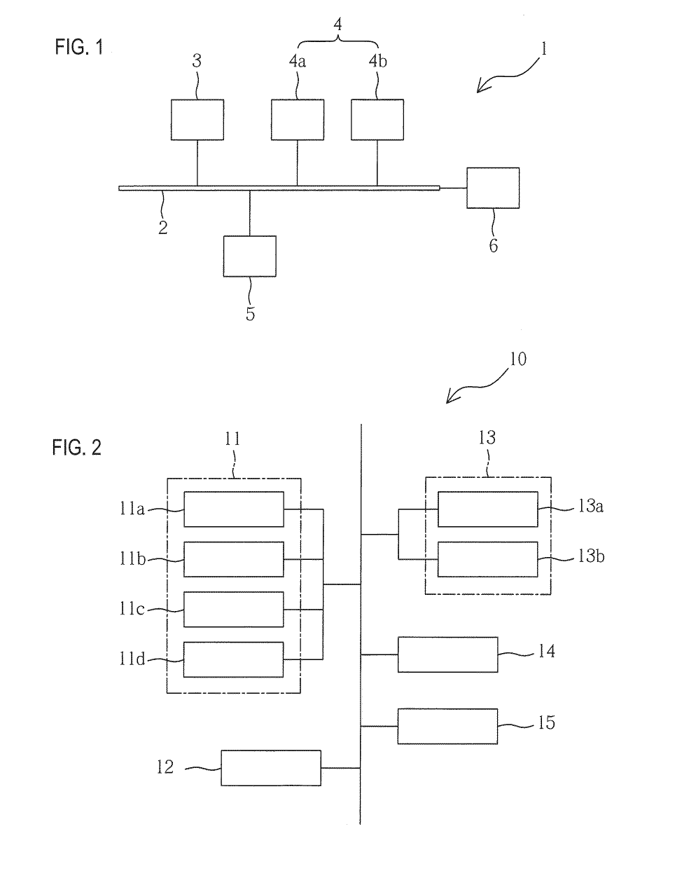

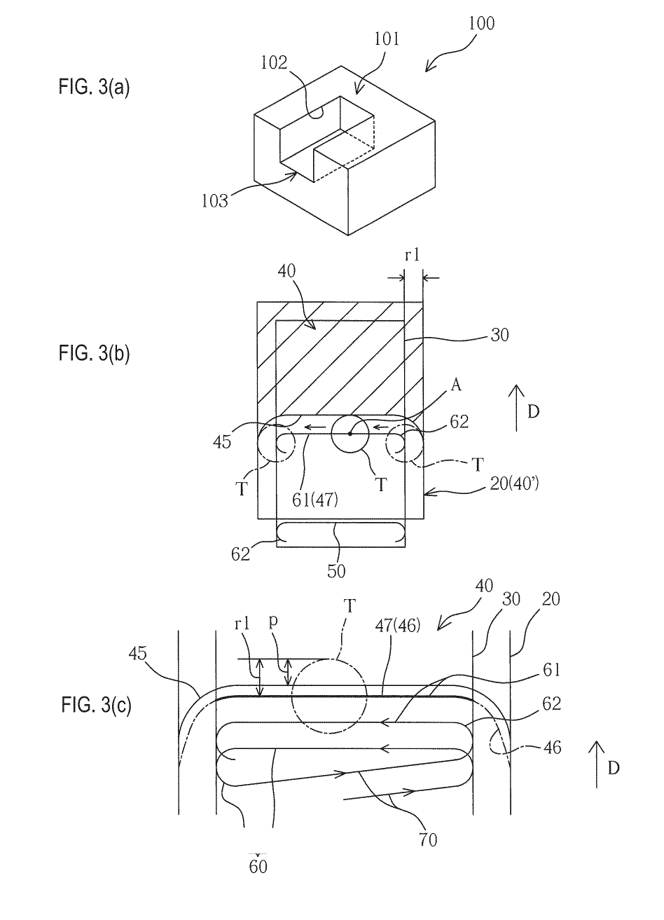

As shown in FIG. 1, in a hardware configuration of a tool path generation apparatus 1 according to the present invention, a monitor 3 and a processing device 4 including a CPU 4a and a memory 4b are connected to a bus 2 including an address bus and a data bus, and an input device 5 including a keyboard, a mouse, and the like for operation is further connected to the bus 2. A computer program 10 shown in FIG. 2 is stored in a hard disk, a RAM, or the like included in the memory 4b, and is operated on the basis of an instruction from the input device 5, processing is performed by the CPU 4a, and a result of the processing is displayed on the monitor 3. Created data is inputted as CAM data into an NC device 6, and cutting is performed.

As shown in FIG. 2, the program 10 to be executed as the tool path generation apparatus 1 according to the present invention generally includes a machining condition setting section 11, a contour line setting section 12, a machining path generation section 13, an unmachined portion update section 14, and a connection path generation section 15. The machining condition setting section 11 generally includes a dimension condition setting section 11a, a tool movement limit line setting section 11b, an initial unmachined portion setting section 11c, and a machining start path setting section 11d. In addition, the machining path generation section 13 includes a cutting path generation section 13a and a return path generation section 13b.

The dimension condition setting section 11a sets a pitch p (an amount of cutting-in with respect to a cut part 101 in a tool radial direction), a radius r2 of each return path 62, and a tool diameter d of a selected cutting tool T, as cutting conditions. These conditions are set by being inputted through the input device 5, and are used for processing in each section described below.

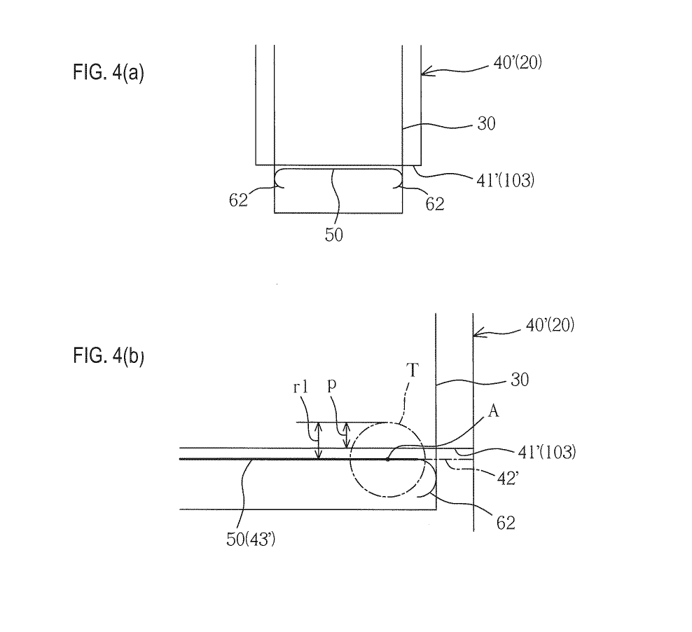

The tool movement limit line setting section 11b inwardly offsets a machining range 20 based on shape data of the cut part 101 by a radius r1 of the tool T to set a tool movement limit line 30. The machining range 20 is shape data of the cut part 101 extracted from CAD data of a work piece 100, and is a portion (region) that should be cut away from a raw material by cutting. In an example of the work piece 100 shown in FIG. 3(a), the internal region of a contour 102 (a line of the boundary between the material and the space) on a plane orthogonal to the amount of cutting-in (depth) with respect to the cut part 101 in the axial direction of the tool T is the machining range 20. The tool movement limit line 30 is a line indicating a region where later-described machining paths 60 (a tool path TP) can be generated. If the tool T moves within this region, the tool T does not interfere with a product shape. Thus, the tool T moving on the generated machining path 60 does not interfere with the work piece 100. The machining range 20 and the tool movement limit line 30 are determined on the basis of the shape of the cut part 101, and thus are unchanged during a procedure of generating the tool path TP. At an opening 103, the machining range 20 may be offset outward of the machining range 20 by the tool radius r1 or greater.

In the example of FIG. 3, the tool T moves from right to left in the drawing to cut the machining range 20, and cutting proceeds from the lower side toward the upper side in the drawing. The tool path TP is a trajectory on which the center of the tool T moves, and includes a machining start path 50, the machining paths 60 (cutting paths 61 and the return paths 62), and connection paths 70 that connects these paths.

The initial unmachined portion setting section 11c sets the above-described machining range 20 as an initial unmachined portion 40′. An unmachined portion 40 indicates a portion of the machining range 20 that should be cut now. That is, the initial unmachined portion 40′ is identical to the machining range 20. The unmachined portion 40 is changeable so as to be updated and reduced by the unmachined portion update section 14 described later.

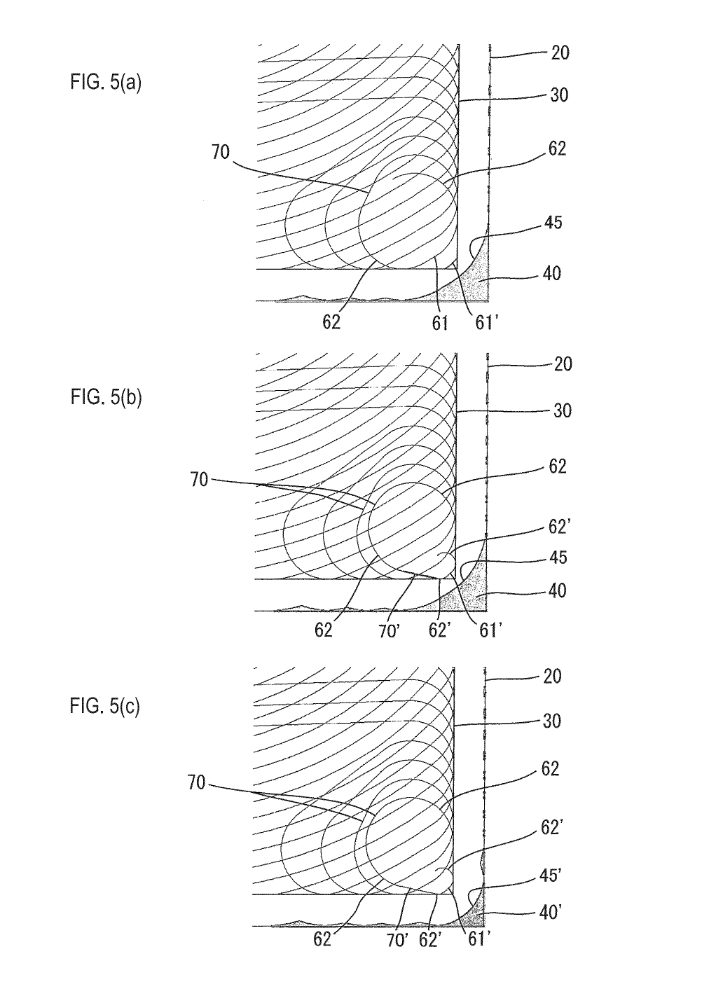

The machining start path setting section 11d generates the machining start path 50 from which cutting the initial unmachined portion 40′ is started. Here, in the case where the cut part 101 has a shape having the opening 103 at at least a part of the outer periphery on a plane orthogonal to a rotation axis of the tool T (FIG. 3(a), an open pocket), the machining start path setting section 11d offsets a contour line 41′ of the initial unmachined portion 40′ corresponding to the opening 103 by the difference between the radius r1 of the tool T and the pitch p (the amount of cutting-in), and extracts a portion 43′ located at an offset contour line 42′ and within the interior of the tool movement limit line 30, to generate the machining start path 50 as shown in FIG. 4. Then, the return paths 62 described later are imparted to both ends of the machining start path 50. Accordingly, the tool T can be caused to enter smoothly along the opening 103, so that an increase in tool load is prevented.

The contour line setting section 12 sets a contour line 45 of a portion that is to be cut by the tool T. As shown in FIGS. 3(b) and (c), the contour line 45 is not the contour (entire periphery) of the unmachined portion 40, and is a portion where the tool T enters the unmachined portion 40. That is, the contour line 45 is the boundary, in the machining range 20, between a portion regarded as having been already cut and a portion regarded as not having been cut yet on the basis of the generated machining path 60. Each time the unmachined portion 40 is updated by the unmachined portion update section 14 described later, the contour line 45 is newly obtained on the basis of the updated unmachined portion 40.

The machining path generation section 13 generates the cutting path 61 within the interior of the tool movement limit line 30 and imparts the return paths 62 having a circular arc shape to both ends of the cutting path 61 to generate the machining path 60. The cutting path 61 mainly indicates a path for cutting the cut part 101, and each return path 62 mainly indicates a path in order for the tool to move from the cutting path 61 to the next cutting path 61. Since the machining path 60 is generated within the interior of the tool movement limit line 30, the final shape of the work piece 100 is not impaired. In addition, it is not necessary to lift the tool T moving on the tool path TP, and the machining efficiency is also good.

As shown in FIG. 3(c), the cutting path generation section 13a offsets the contour line 45 by the difference between the radius r1 of the tool T and the pitch p and extracts a portion 47 located at an offset contour line 46 and within the interior of the tool movement limit line 30, to generate the cutting path 61. The direction of the offset is a direction opposite to a proceeding direction D of cutting.

The return path generation section 13b imparts the return paths 62 having a circular arc shape to both ends of the generated cutting path 61 in the direction in which the contour line 45 is offset. As shown in FIG. 3(c), each return path 62 is obtained as a circular arc that is in contact with both the cutting path 61 and the tool movement limit line 30. Accordingly, a sudden path change in the tool path is prevented, a smooth path is provided, and an excessive increase in tool load is suppressed.

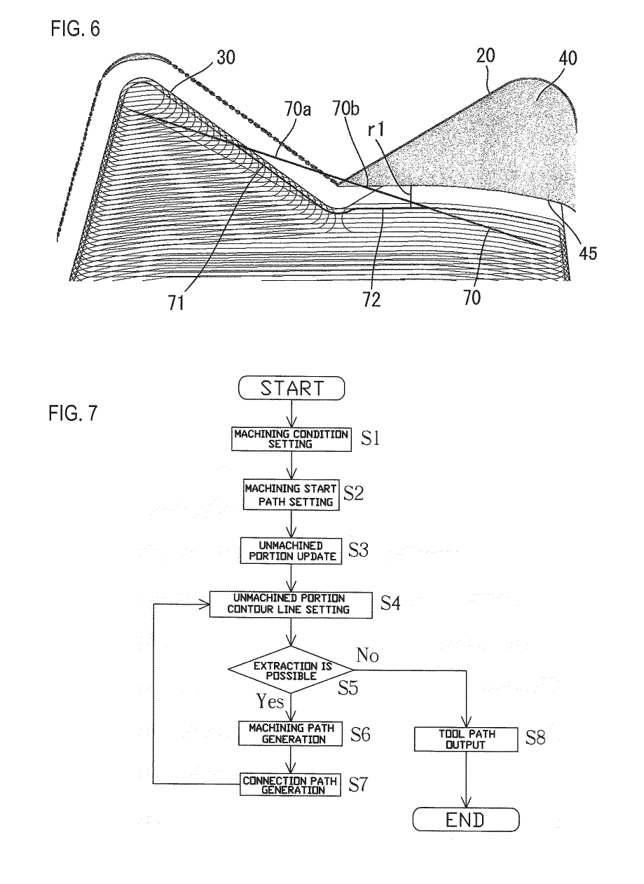

In addition, when the return path generation section 13b cannot impart a return path 62′ to a next cutting path 61′ within the interior of the tool movement limit line 30, the return path generation section 13b reduces a radius r2 of the return path 62′ such that the return path 62′ falls within the interior of the tool movement limit line 30. For example, in an example of FIG. 5(a), the next cutting path 61′ is obtained on the basis of the unmachined portion 40, but, since the set radius r2 of the return path 62 is large, the return path 62 cannot be imparted to the next cutting path 61′. Thus, as shown in FIG. 5(b), the return path radius r2 is reduced such that the return path 62 falls within the interior of the tool movement limit line 30. Accordingly, the return path 62′ having a radius r2′ is imparted to the cutting path 61′. Therefore, as shown in FIG. 5(c), the unmachined portion 40 can be updated on the basis of the generated machining path 60, so that a remaining portion to be cut decreases and the machining efficiency also improves.

The unmachined portion update section 14 removes a tool movement region W formed by the tool T moving according to the machining start path 50 or the machining path 60, from the unmachined portion 40 in the machining range 20 to update the unmachined portion 40. Accordingly, the updated unmachined portion 40 indicates a region that should be cut with the next machining path 60 and the subsequent machining paths 60. That is, the unmachined portion 40 does not include the portion that has been cut (machined), the next machining path 60 is generated on the basis of the unmachined portion 40, and thus machining the same portion twice can also be prevented.

The connection path generation section 15 generates the connection path 70 that connects the presently generated machining path 60 to the immediately previously generated machining path 60. The connection path 70 is generated as a line segment that connects the return path 62 of the machining path 60 and the return path 62 of the next machining path 60 such that directions in which the tool T advances on the cutting path 61 of the presently generated machining path 60 and the cutting path 61 of the immediately previously generated machining path 60 coincide with each other. As shown in FIG. 3(c), in the present embodiment, this line segment is also obtained as a tangential line that is in contact with both the circular art of the return path 62 of the machining path 60 and the circular art of the return path 62 of the next machining path 60. Accordingly, in moving to the next machining path 60, the tool path is not suddenly changed, and an excessive increase in tool load can be prevented. In addition, since the line segment is a tangential line, the connection path can connect the machining paths in a shortest distance, which is efficient.

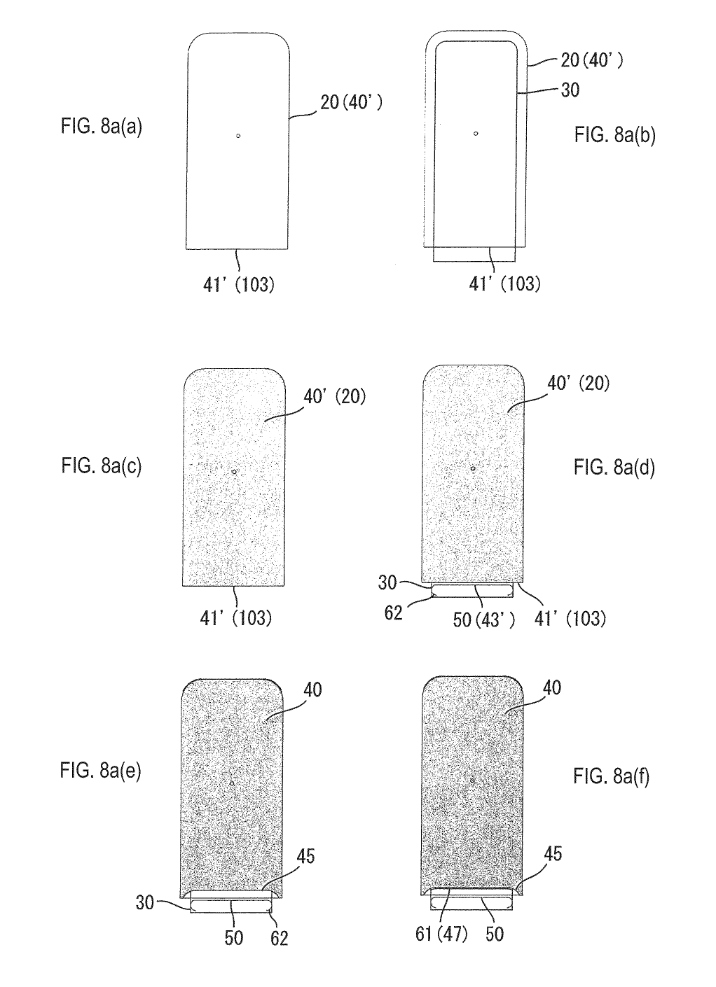

However, the connection path 70 may be extended to the outside of the tool movement limit line 30. As shown in FIG. 6, the connection path 70 is generated so as to extend from the return path 62 at the left side on the drawing to the return path 62 at the right side on the drawing through the outside of the tool movement limit line 30. In this case, a connection path 70a that is the extension portion is corrected so as to extend along the tool movement limit line 30 to generate a bypass line 71. Furthermore, there is also a case where the tool moving on the connection path 70 interferes with the unmachined portion 40. In the example of FIG. 6, a connection path 70b that is the interference portion is corrected so as to extend along a bypass line 72 that is offset from the unmachined portion 40 by the radius r1 of the tool T. By these corrections, interference with the shape of the work piece 100 or the unmachined portion 40 is prevented.

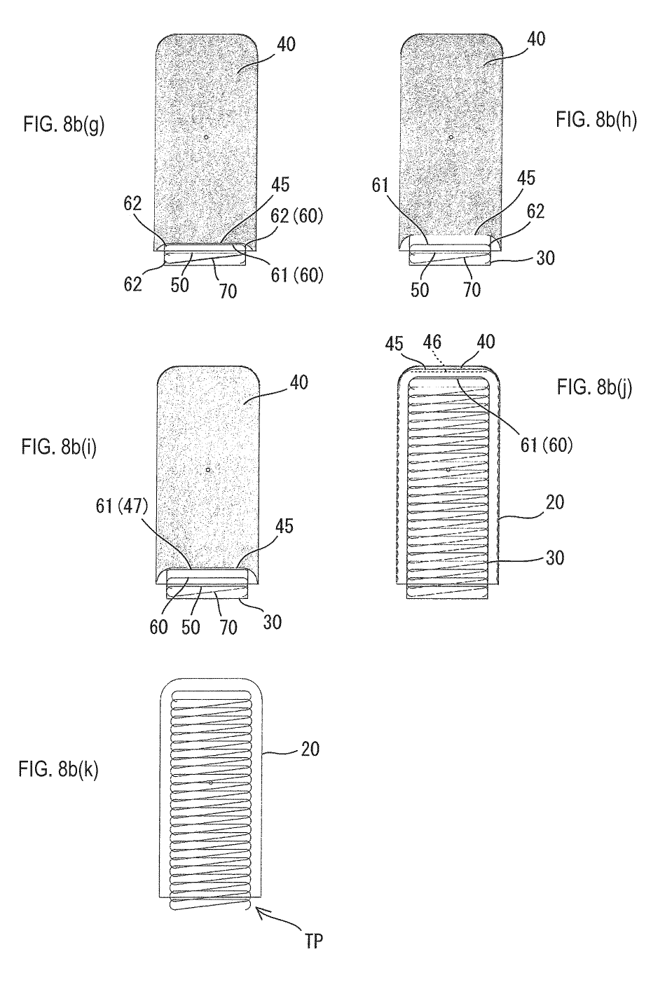

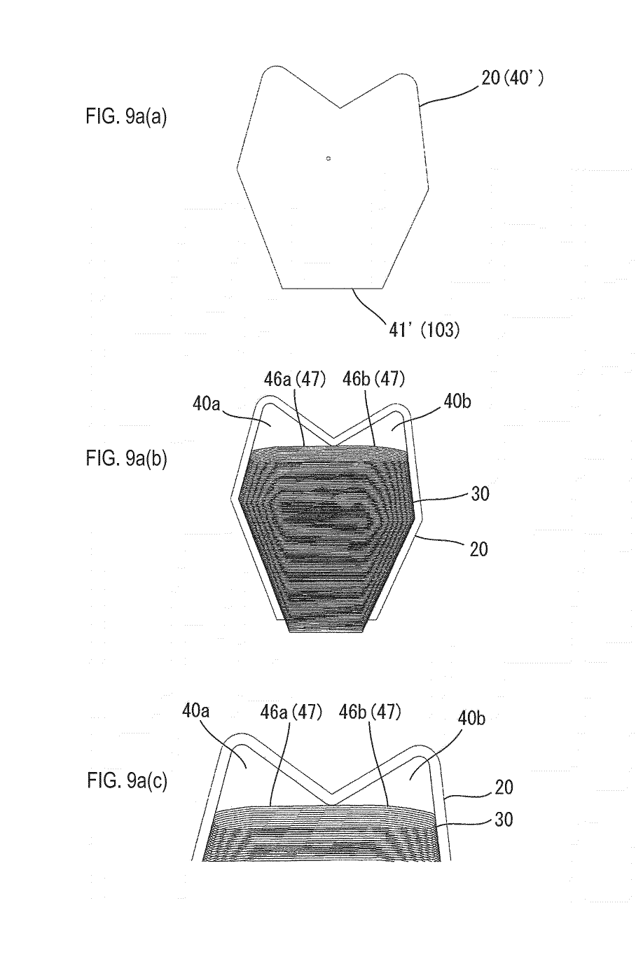

Here, a tool path generation method will be described with reference to FIGS. 7, 8a, and 8b. As shown in FIG. 7, the tool path generation method according to the present invention generally includes a machining condition setting step S1, a machining start path generation step S2, an unmachined portion update step S3, an unmachined portion contour line setting step S4, a machining path generation step S6, and a connection path generation step S7.

First, in the machining condition setting step S1, the dimension condition setting section 11a sets the pitch p, the radius r2 of each return path, and the tool diameter d (radius r1) of the selected cutting tool T that are inputted through the input device 5. The tool movement limit line setting section 11b sets the machining range 20 on the basis of the read shape data (CAD data) of the cut part 101 of the work piece 100 (FIG. 8a(a)), and sets the tool movement limit line 30 on the basis of the machining range 20 (FIG. 8a(b)). In addition, the initial unmachined portion setting section 11c sets the set machining range 20 as the initial unmachined portion 40′ (FIG. 8a(c)).

Next, in the machining start path generation step S2, the machining start path setting section 11d generates the machining start path 50 from which cutting the initial unmachined portion 40′ that is set by the initial unmachined portion setting section 11c is started. In the case where the cut part 101 is an open pocket, the machining start path setting section 11d generates the machining start path 50 on the basis of the initial unmachined portion 40′ corresponding to the opening 103 (FIG. 8a(d)). Then, this machining start path 50 is set as a present machining path.

Next, in the unmachined portion update step S3, the unmachined portion update section 14 removes the tool movement region W formed by the tool T moving according to the present machining path generated by the machining start path setting section 11d or the machining path generation section 13, from the unmachined portion 40 to update the unmachined portion 40 (FIG. 8a(e)).

Next, in the unmachined portion contour line setting step S4, the contour line setting section 12 newly sets a contour line 45 of a portion to be cut by the tool T in the unmachined portion 40 updated by the unmachined portion update section 14 (FIG. 8a(e)). Then, the machining path generation section 13 offsets the contour line 45, which is obtained by the contour line setting section 12, by the difference between the tool radius r1 and the pitch p and extracts (calculates) a portion 47 located within the interior of the tool movement limit line 30, which is set by the tool movement limit line setting section 11b, from an offset contour line 46. Here, if the portion 47 cannot be extracted (FIG. 8b(j), step S5), the machining path generated and connected so far is outputted as the tool path TP (FIG. 8b(k), step S8), and the processing is ended. For example, in the example of FIG. 8b(j), the unmachined portion 40 is present, but the contour line 46 offset on the basis of the unmachined portion 40 is located outside the tool movement limit line 30, and there is no portion 47 located within the interior of the tool movement limit line 30. Thus, generation of the machining path 60 is ended. On the other hand, if the portion 47 is extracted, the processing proceeds to the next machining path generation step S6.

In the machining path generation step S6, the machining path generation section 13 generates, as the cutting path 61, the portion 47 extracted in the previous unmachined portion contour line setting step S4 (FIG. 8a(f)), and imparts the return paths 62 having a circular arc shape to both ends of the cutting path 61, to generate the machining path 60 (FIG. 8b(g)). Here, if the return path 62 does not fall within the interior of the tool movement limit line 30, the return path generation section 13b adjusts the return path radius r2. Then, the generated machining path 60 is set as a present machining path.

Next, in the connection path generation step S7, the connection path generation section 15 generates the connection path 70 that connects the present machining path 60 generated by the machining path generation section 13 to the immediately previously generated machining path 60, to connect these machining paths 60 (FIG. 8b(g)). If at least a part of the generated connection path 70 extends through the outside of the tool movement limit line 30 or interferes with the unmachined portion 40, this part of the connection path 70 is corrected.

Then, the processing returns to the above-described unmachined portion update step S3, and the unmachined portion update step S3 to the connection path generation step S7 are sequentially repeatedly performed (FIGS. 8b(h) and (i)) until it becomes impossible to generate the machining path 60 within the interior of the tool movement limit line 30 (FIG. 8b(j)). In this manner, the tool path TP that covers the interior of the tool movement limit line 30 of the machining range 20 and provides good machining efficiency is generated. It should be noted that the unmachined portion remaining outside the tool movement limit line 30 is cut by another method.

Lastly, possibilities of other embodiments of the present invention will be mentioned. It should be noted that the same members as those in the above-described embodiment are designated by the same reference characters.

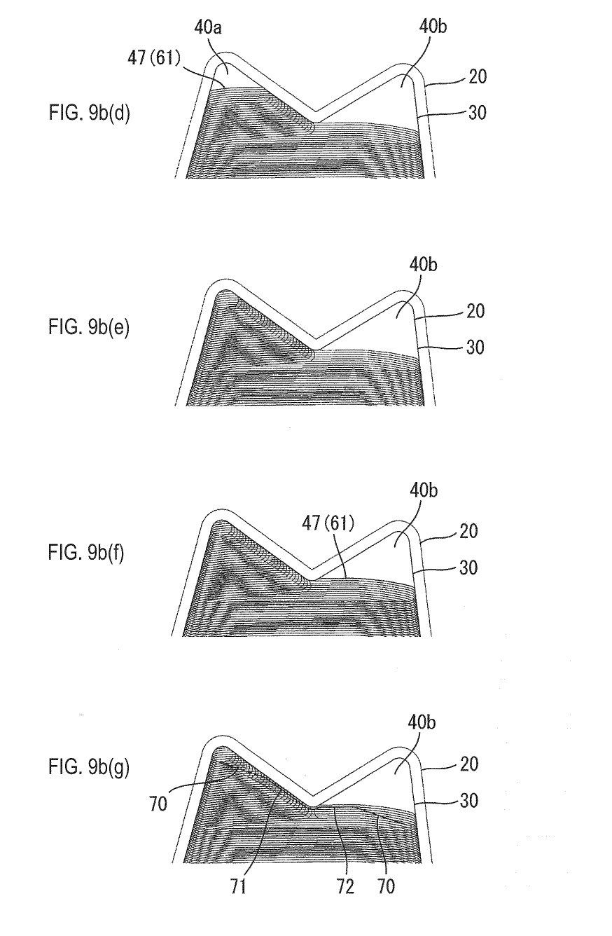

In the above-described embodiment, the example where the unmachined portion 40 is not separately generated has been described. However, for example, with a shape as shown in FIG. 9, the unmachined portion 40 is separately generated in the procedure of generating the tool path TP. In this case, when the offset contour line 46 is generated so as to be in contact with the tool movement limit line 30, the unmachined portion 40 is separately generated (FIGS. 9a(b) and (c)). Here, either offset contour line 46 is selected, and the processing is continued on one unmachined portion 40a (FIG. 9b(d)). Then, when path generation at the one unmachined portion 40a is completed (FIG. 9b(e)), the processing shifts to another unmachined portion 40b (FIG. 9b(f)). In this example, the connection path 70 is corrected so as to avoid intersection with the tool movement limit line 30 and tool interference with the unmachined portion 40 (FIG. 9b(g)). In this manner, generation of the continuous tool path TP can be performed in a simple manner even when a plurality of offset contour lines 46 are obtained (branch).

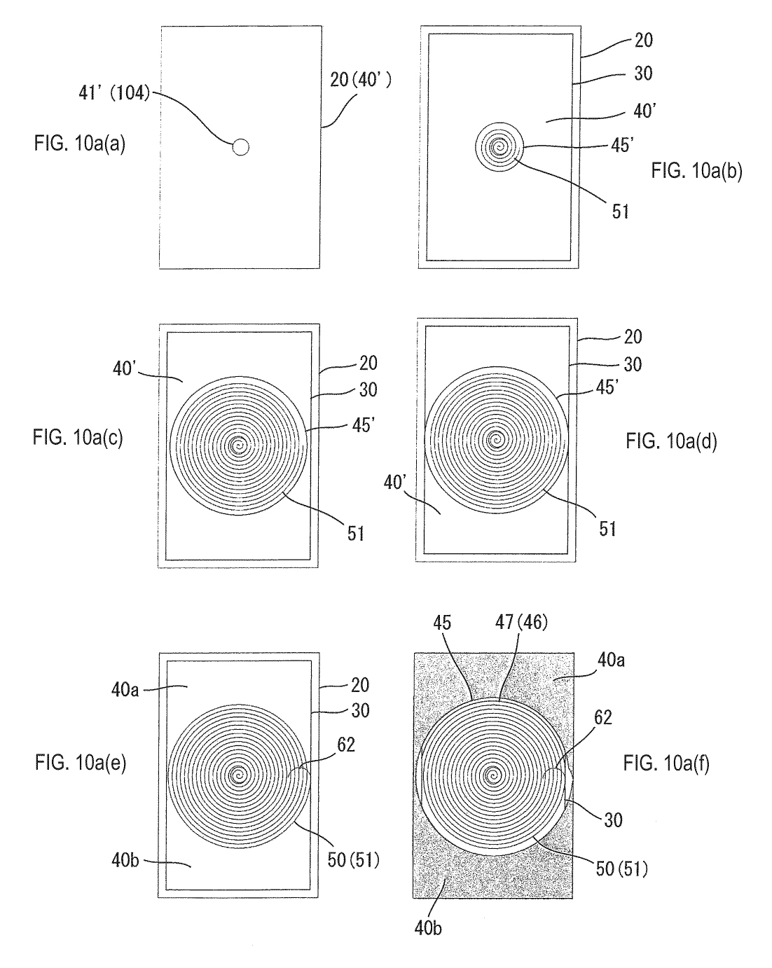

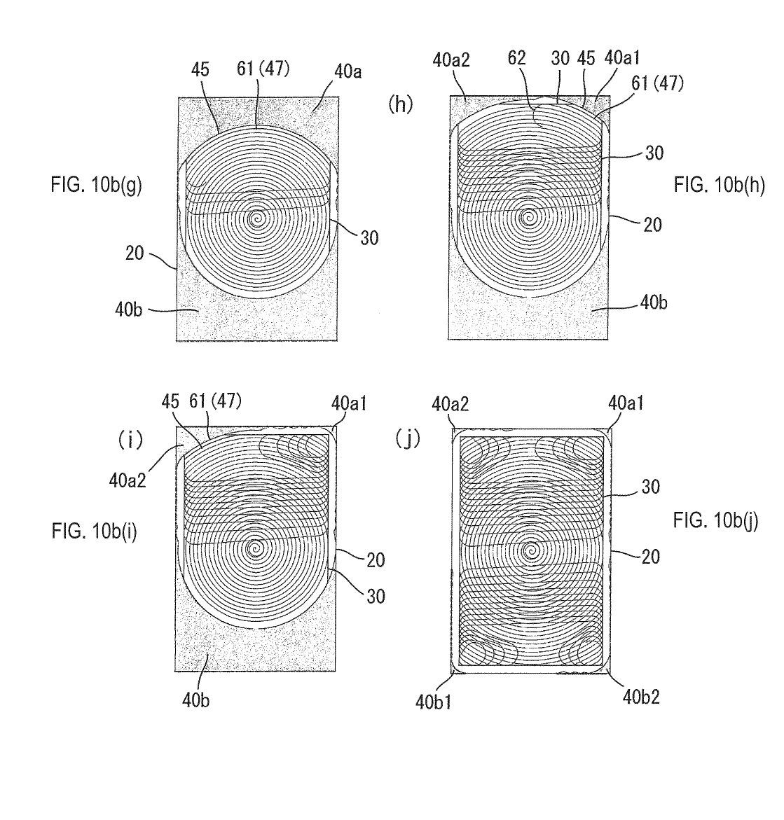

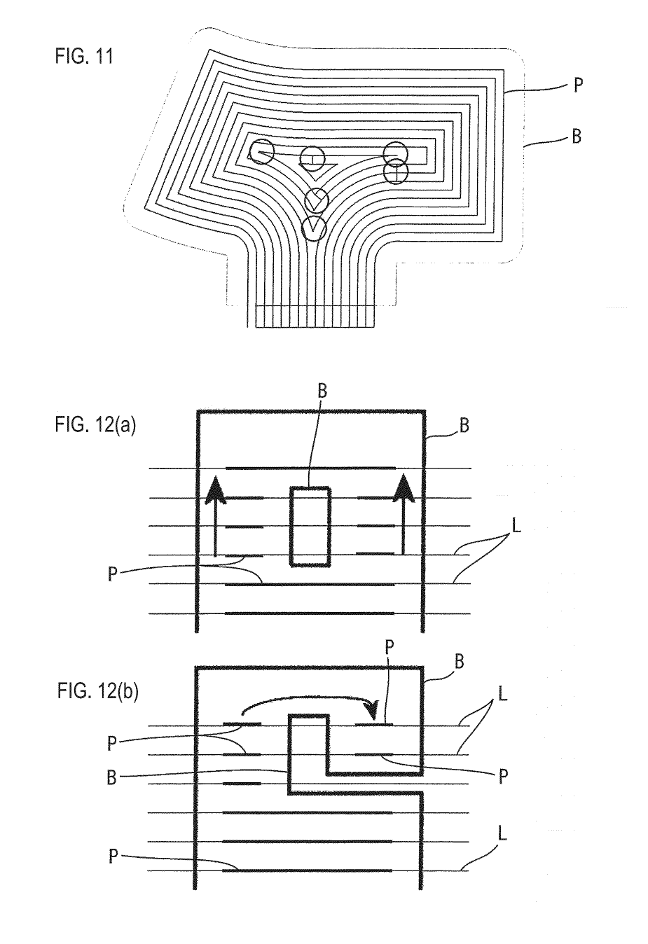

In the above-described embodiment, generation of the tool path TP in the case where the cut part 101 is an open pocket has been described. However, a shape (a closed pocket) having a closed outer periphery on the plane orthogonal to the rotation axis of the tool T as shown in FIG. 10 is possible. In this case, an introduction portion 104 through which the tool T is introduced is included (FIG. 10a(a)).

In the case of the closed pocket, the machining start path generation section 11c generates, as the machining start path 50, a spiral 51 that spreads outward at the pitch p from a portion 41′ of the initial unmachined portion 40′ corresponding to the introduction portion 104 until coming into contact with the tool movement limit line 30 (FIGS. 10a(b) to (d)). In addition, the return path 62 is similarly imparted to the spiral 51 (FIG. 10a(e)). Here, reference character 45′ indicates a circle having a radius that is a length obtained by adding the tool radius r1 to a straight line from the center of the spiral 51 to the end of the spiral 51. Then, the unmachined portion update section 14 described later updates the initial unmachined portion 40′ on the basis of the machining start path 50, and the machining path generation section 13 described later generates a next machining path (FIG. 10a(f)). If a plurality of offset contour lines 46 are generated, any of the contour lines 46 is selected similarly as in the above. In the example of FIG. 10a, the offset contour line 46 at the upper side in the drawing is selected, and the processing is continued similarly as in the above-described embodiment (FIGS. 10b(g) to (j)). It should be noted that in this example, adjustment of the radius r2 of the return path 62 is performed as shown in FIG. 5.

In each embodiment described above, generation of the tool path TP in the machining range 20 having a rectangular shape has been described. This shape is merely an example. The shape of the machining range 20 (the shape of the cut part 101) is not limited, and, even with the machining range 20 having an undefined shape, generation of the tool path TP is possible similarly. In addition, in the example of FIG. 10, the spiral 51 that spreads outward at the pitch p is generated as the machining start path 50. However, the machining start path 50 is not limited thereto, and a spiral 51 that spreads inwardly can be generated as the machining start path 50 depending on the shape. As described above, the present invention can be executed regardless of the shape of the machining range 20 (the cut part 101).

In the above-described embodiment, the machining range 20 is inwardly offset by the radius r1 of the tool T to set the tool movement limit line 30. However, the tool movement limit line 30 is not limited thereto, and may be offset, for example, by a machining allowance for a post-step in addition to the radius r1 of the tool T.

In the above-described embodiment, the computer program that causes a computer to function as the tool path generation apparatus is stored in the memory 4b, and the CPU 4a executes this program. However, this program and data can be previously stored in an external storage device such as a magnetic disk device or an optical disk device and can be loaded into the memory 4b to be executed. In addition, this program and data can be stored in a computer-readable storage medium, and this program can be executed via a reading device. Examples of the storage medium include optical disks such as CD-ROM, DVD, and Blu-ray (registered trademark) disk, magneto-optical disks, and flash memories such as USB memory and SD card, etc.

1. A tool path generation apparatus for generating a tool path, for a tool, for moving the rotating tool on a plane orthogonal to a rotation axis of the rotating tool to continuously cut a cut part of a work piece at a predetermined pitch along the plane, the tool path generation apparatus comprising:
a tool movement limit line setting section configured to inwardly offset a machining range based on shape data of the cut part by at least a radius of the tool to set a tool movement limit line;
a contour line setting section configured to set a contour line of a portion that is to be cut by the tool;
a machining path generation section configured to offset the contour line by a difference between the radius of the tool and the pitch and extract a portion located at an offset contour line and within an interior of the tool movement limit line to generate a cutting path, and impart return paths having a circular arc shape to both ends of the cutting path, to generate a machining path;
an unmachined portion update section configured to remove a tool movement region formed by the tool moving according to the machining path, from an unmachined portion in the machining range to update the unmachined portion; and
a connection path generation section configured to generate a connection path that connects the machining path to an immediately previously generated machining path, wherein
until it becomes impossible to generate the machining path within the interior of the tool movement limit line,
the unmachined portion update section updates the unmachined portion on the basis of the machining path, the contour line setting section newly sets the contour line in the updated unmachined portion, the machining path generation section generates a next machining path on the basis of the newly set contour line, and the connection path generation section generates a connection path that connects the generated next machining path and the machining path.

2. The tool path generation apparatus according to claim 1, wherein, when a plurality of the offset contour lines are separately generated by the tool movement limit line, the machining path generation section selects any of the plurality of the generated offset contour lines and generates the next machining path.

3. The tool path generation apparatus according to claim 1, wherein the connection path generation section generates, as the connection path, a line segment that connects the return path of the machining path and a return path of the next machining path such that directions in which the tool advances on the cutting path of the machining path and a cutting path of the next machining path are a certain direction.

4. The tool path generation apparatus according to claim 3, wherein the line segment is a tangential line that is in contact with the return path of the machining path and the return path of the next machining path.

5. The tool path generation apparatus according to claim 3, wherein, when an extension portion that extends through an outside of the tool movement limit line occurs in the connection path, the connection path generation section corrects the extension portion of the connection path such that the extension portion extends along the tool movement limit line.

6. The tool path generation apparatus according to claim 3, wherein, when an interference portion that interferes with the unmachined portion occurs in the connection path, the connection path generation section corrects the interference portion of the connection path such that the interference portion extends along a bypass line that is offset from the unmachined portion by the radius of the tool.

7. The tool path generation apparatus according claim 1, wherein, when the return path cannot be imparted to the next machining path within the interior of the tool movement limit line, the machining path generation section reduces a radius of the return path such that the return path falls within the interior of the tool movement limit line.

8. The tool path generation apparatus according claim 1, further comprising:
an initial unmachined portion setting section configured to set the machining range as an initial unmachined portion; and
a machining start path generation section configured to generate a machining start path from which cutting the initial unmachined portion is started, wherein
when the cut part has a shape having an opening at at least a part of an outer periphery on the plane,
the machining start path generation section offsets a contour line of the initial unmachined portion corresponding to the opening by the difference between the radius of the tool and the pitch, and extracts a portion located at an offset contour line and within the interior of the tool movement limit line, to generate the machining start path, and
the unmachined portion update section removes the tool movement region from the initial unmachined portion according to the machining start path to update the unmachined portion.

9. The tool path generation apparatus according claim 1, further comprising:
an initial unmachined portion setting section configured to set the machining range as an initial unmachined portion; and
a machining start path generation section configured to generate a machining start path from which cutting the initial unmachined portion is started, wherein
when the cut part includes an introduction portion through which the tool is introduced, and has a shape having a closed outer periphery on the plane,
the machining start path generation section sets, as the machining start path, a spiral having the pitch and extending from a portion corresponding to the introduction portion until coming into contact with the tool movement limit line, and
the unmachined portion update section removes the tool movement region from the initial unmachined portion according to the machining start path to update the unmachined portion.

10. A tool path generation method for generating a tool path, for a tool, for moving the rotating tool on a plane orthogonal to a rotation axis of the rotating tool to continuously cut a cut part of a work piece at a predetermined pitch along the plane, the tool path generation method comprising:
a tool movement limit line setting step of inwardly offsetting a machining range based on shape data of the cut part by at least a radius of the tool to set a tool movement limit line;
a contour line setting step of setting a contour line of a portion that is to be cut by the tool;
a machining path generation step of offsetting the contour line by a difference between the radius of the tool and the pitch and extracting a portion located at an offset contour line and within an interior of the tool movement limit line to generate a cutting path, and imparting return paths having a circular arc shape to both ends of the cutting path, to generate a machining path;
an unmachined portion update step of removing a tool movement region formed by the tool moving according to the machining path, from an unmachined portion in the machining range to update the unmachined portion; and
a connection path generation step of generating a connection path that connects the machining path to an immediately previously generated machining path, wherein
until it becomes impossible to generate the machining path within the interior of the tool movement limit line,
repeatedly, the unmachined portion is updated by the unmachined portion update step on the basis of the machining path, the contour line in the updated unmachined portion is newly set by the contour line setting step, a next machining path is generated by the machining path generation step on the basis of the newly set contour line, and a connection path that connects the generated next machining path and the machining path is generated by the connection path generation step.

11. (canceled)

12. A computer-readable storage medium having stored therein a program for causing a computer to function as a tool path generation apparatus for generating a tool path, for a tool, for moving the rotating tool on a plane orthogonal to a rotation axis of the rotating tool to continuously cut a cut part of a work piece at a predetermined pitch along the plane, the program causing the computer to function as:
tool movement limit line setting means for inwardly offsetting a machining range based on shape data of the cut part by at least a radius of the tool to set a tool movement limit line;
contour line setting means for setting a contour line of a portion that is to be cut by the tool;
machining path generation means for offsetting the contour line by a difference between the radius of the tool and the pitch and extracting a portion located at an offset contour line and within an interior of the tool movement limit line to generate a cutting path, and imparting return paths having a circular arc shape to both ends of the cutting path, to generate a machining path;
unmachined portion update means for removing a tool movement region formed by the tool moving according to the machining path, from an unmachined portion in the machining range to update the unmachined portion; and
connection path generation means for generating a connection path that connects the machining path to an immediately previously generated machining path, wherein
until it becomes impossible to generate the machining path within the interior of the tool movement limit line,
the unmachined portion update means updates the unmachined portion on the basis of the machining path, the contour line setting means newly sets the contour line in the updated unmachined portion, the machining path generation means generates a next machining path on the basis of the newly set contour line, and the connection path generation means generates a connection path that connects the generated next machining path and the machining path.

13. The tool path generation apparatus according to claim 2, wherein the connection path generation section generates, as the connection path, a line segment that connects the return path of the machining path and a return path of the next machining path such that directions in which the tool advances on the cutting path of the machining path and a cutting path of the next machining path are a certain direction.

14. The tool path generation apparatus according to claim 13, wherein the line segment is a tangential line that is in contact with the return path of the machining path and the return path of the next machining path.

15. The tool path generation apparatus according to claim 4, wherein, when an extension portion that extends through an outside of the tool movement limit line occurs in the connection path, the connection path generation section corrects the extension portion of the connection path such that the extension portion extends along the tool movement limit line.

16. The tool path generation apparatus according to claim 13, wherein, when an extension portion that extends through an outside of the tool movement limit line occurs in the connection path, the connection path generation section corrects the extension portion of the connection path such that the extension portion extends along the tool movement limit line.

17. The tool path generation apparatus according to claim 14, wherein, when an extension portion that extends through an outside of the tool movement limit line occurs in the connection path, the connection path generation section corrects the extension portion of the connection path such that the extension portion extends along the tool movement limit line.

18. The tool path generation apparatus according to claim 4, wherein, when an interference portion that interferes with the unmachined portion occurs in the connection path, the connection path generation section corrects the interference portion of the connection path such that the interference portion extends along a bypass line that is offset from the unmachined portion by the radius of the tool.

19. The tool path generation apparatus according to claim 13, wherein, when an interference portion that interferes with the unmachined portion occurs in the connection path, the connection path generation section corrects the interference portion of the connection path such that the interference portion extends along a bypass line that is offset from the unmachined portion by the radius of the tool.

20. The tool path generation apparatus according to claim 14, wherein, when an interference portion that interferes with the unmachined portion occurs in the connection path, the connection path generation section corrects the interference portion of the connection path such that the interference portion extends along a bypass line that is offset from the unmachined portion by the radius of the tool.
